(19) United States
(12) Patent Application Publication
(10) Pub. No.: US 2025/0025910 A1
(43) Pub. Date: Jan. 23, 2025

(54) STRAIGHT PAINT ROLLER AND CONTAINER

(71) Applicants: Kenneth Steven McELWAIN, Seville, OH (US); Terry Glenn Nodine, Raleigh, NC (US)

(72) Inventors: Kenneth Steven McELWAIN, Seville, OH (US); Terry Glenn Nodine, Raleigh, NC (US)

(21) Appl. No.: 18/354,454

(22) Filed: Jul. 18, 2023

(51) Int. Cl. B05C 17/02; B44D 3/12

(52) U.S. Cl. CPC B05C 17/0217; B05C 17/0205; B44D 3/123

(57) ABSTRACT

A paint roller is provided having a substantially linear profile and form factor facilitating access to spaces that would be difficult or impossible to paint using traditional paint rollers. A container is provided for use with the paint roller. A set comprising a paint roller having a substantially linear profile and container configured to accept the paint roller is provided.

### TECHNICAL FIELD

The present inventions generally relate to apparatuses for applying paint, and more particularly relate to specialized paint rollers and paint containers.

### BACKGROUND OF THE INVENTION

A popular method of painting surfaces is with the use of a paint roller. A paint roller typically has two parts: a roller frame and a roller cover. The roller frame typically has a rotatable end and a handle end. The roller cover is fitted on top of a rotatable end of the roller frame, and the paint roller is held by a painter on the handle end. The long axis of the roller frame is at an approximately right angle to the long axis of the handle, aligning the roller cover accordingly. A paint tray used with rollers has a shallow recess that holds paint, and a floor that angles upward to allow the roller to be removed and paint evenly distributed in desired volumes by rolling the roller cover over a portion of the tray not containing paint. The roller, thus holding the painter's desired amount of paint in the roller cover, can then be used to apply paint to a surface. The roller frame is reusable, but the roller cover is typically disposed of after use.

While useful and time-efficient with painting unobstructed, flat areas like walls, a paint roller cannot effectively paint around or between narrow areas. Therefore, small areas, such as the area between picket fences or behind a toilet, have to be painted by a hand brush, which can be slow and cumbersome, and which may leave a different texture or appearance than that of areas that were painted using a roller. Even smaller paint rollers have difficulty painting narrow areas due to the angle between the handle and roller frame.

Another problem with traditional paint rollers is the need for a roller tray. Roller trays are require significant support under a level surface to prevent deformation and spilling, and are generally unsteady. Efforts to make roller trays deeper compromise their utility with rollers by making it more difficult to recoat a roller cover, evenly distribute paint over a roller cover, remove excess paint from the roller cover, et cetera.

Used paint rollers typically cannot be stored in paint trays, as both the paint stored in the paint trays and the paint absorbed in the paint rollers will dry and ruin subsequent uses of such materials, or require timely cleaning. Additionally, a paint roller stored in a used paint tray will likely get paint all over the handle end and roller frame.

As such, it is believed there is a need for a paint roller that can efficiently paint narrow and hard-to-reach areas, and a container that can recoat and store such a paint roller, and store extra paint securely (e.g., without a large open top and wide footprint as is the case with trays for paint rollers) during the painting process.

### SUMMARY OF THE INVENTION

In an embodiment, a paint roller is disclosed. The paint roller comprises a paint roller frame extending along a long axis of the paint roller; a paint roller handle fixedly attached to a first end of the frame; and a paint roller cover attached over a second end of the paint roller frame, wherein at least a portion of the frame paint roller cover is configured to rotate with respect to the paint roller handle.

In an embodiment, a container for a paint roller is disclosed. The container comprises a cylinder portion disposed at a top of the container, wherein the cylinder portion has an open top end configured to accept the paint roller; a reservoir portion coupled with the cylinder portion, wherein the reservoir portion is configured to receive an amount of paint, wherein the reservoir portion is narrower than the cylinder portion, and wherein the reservoir portion has a larger cross-sectional dimension than a cross-sectional dimension of the paint roller cover; and a base portion disposed at a bottom of the container, wherein the base portion is configured to stabilize the container.

In an embodiment, a painting set comprising a paint roller and a container is disclosed. The paint roller comprises a paint roller frame extending along a long axis of the paint roller; a paint roller handle fixedly attached to a first end of the frame; and a paint roller cover attached over a second end of the paint roller frame, wherein at least a portion of the frame paint roller cover is configured to rotate with respect to the paint roller handle. The container comprises a cylinder portion disposed at a top of the container, wherein the cylinder portion has an open top end configured to accept the paint roller; a reservoir portion coupled with the cylinder portion, wherein the reservoir portion is configured to receive an amount of paint, wherein the reservoir portion is narrower than the cylinder portion, and wherein the reservoir portion has a larger cross-sectional dimension than a cross-sectional dimension of the paint roller cover; and a base portion disposed at a bottom of the container, wherein the base portion is configured to stabilize the container.

The aspects set forth in the above Summary are intended to provide examples of aspects for some embodiments, and should not be deemed as requiring any element in a particular embodiment or limiting the scope or spirit of the disclosure.

### BRIEF DESCRIPTION OF THE DRAWINGS

These and other features and advantages of the present invention will become better understood with regard to the following description, appended claims, and accompanying drawings wherein:

FIG. 1 is a perspective view of a painting set comprising a paint roller and a container constructed according to the principles of the present invention;

FIG. 2 is a sectional side view of a painting showing the paint roller stored inside of the container;

FIG. 3 is a sectional side view of a painting set showing the paint roller hooked on an open end of the container;

FIG. 4 is a side view of the container including a cap connected to the open end of the container;

FIG. 5 is a side view of the container including a cap with a recess connected to the open end of the container;

FIG. 6 is a sectional side view of a painting set including a cap with a recess connected to the open end of the container;

FIG. 7 is a side view of the container including a gripping element connected to a side of the container;

FIG. 8 is a wide view of the container including an alternate gripping element connected to a side of the container;

FIG. 9 is a sectional side view of the container including an internal textured surface made of vertical ridges;

FIG. 10 is a sectional side view of the container including an internal textured surface made of a plurality of ridges;

FIG. 11 is an illustration of an example roller disclosed herein arranged within an example container disclosed herein;

FIG. 12 is an illustration of an example paining set disclosed herein;

FIG. 13 is an illustration of an example painting set disclosed herein;

FIG. 14A is an illustration of an example container disclosed herein;

FIG. 14B is an illustration of an example container disclosed herein;

FIG. 14C is an illustration of an example container disclosed herein; and

FIG. 14D is an illustration of an example container disclosed herein.

The aspects set forth in the above Brief Description of the Drawings are intended to provide examples of aspects for some embodiments, and should not be deemed as requiring any element in a particular embodiment or limiting the scope or spirit of the disclosure.

### DETAILED DESCRIPTION

Example embodiments and features described herein are directed to paint rollers, paint roller containers, painting sets of rollers and containers, and methods of using or making the same.

In one embodiment, the paint roller is used in conjunction with the paint roller container. The paint roller is designed to reach narrow or hard-to-reach areas. The frame (and cover applied) and handle can be aligned along the same (or approximately the same) long axis. The paint roller container can be filled with a desired paint (or other liquids, gels, et cetera, that can be applied by roller). The paint roller can be arranged within the paint roller container to apply paint to a roller. On removal, excess paint can be scraped or wiped off in the paint roller container before using the roller for painting.

The paint roller and container are configured such that the paint roller can be stored inside the paint roller container. In some embodiments, the paint roller container may have a cap with a recess. The cap is configured to fit over the paint roller, and keeps an airtight seal. In another feature, the paint roller container may have a gripping element connected to the outer side of the paint roller container to allow a painter to holder the paint roller container during using. The recess may be centered or arranged in any other manner such that the handle of the paint roller can nest therein. Other means of retaining the paint roller in a particular manner in the container are disclosed herein.

In further alternative or complementary embodiments, the paint roller container may have an internal textured surface that helps to redistribute or remove excess paint from the paint roller. Because the vertical arrangement of the paint roller and container may result in a greater amount of paint applied to the end of the roller distal to the handle,

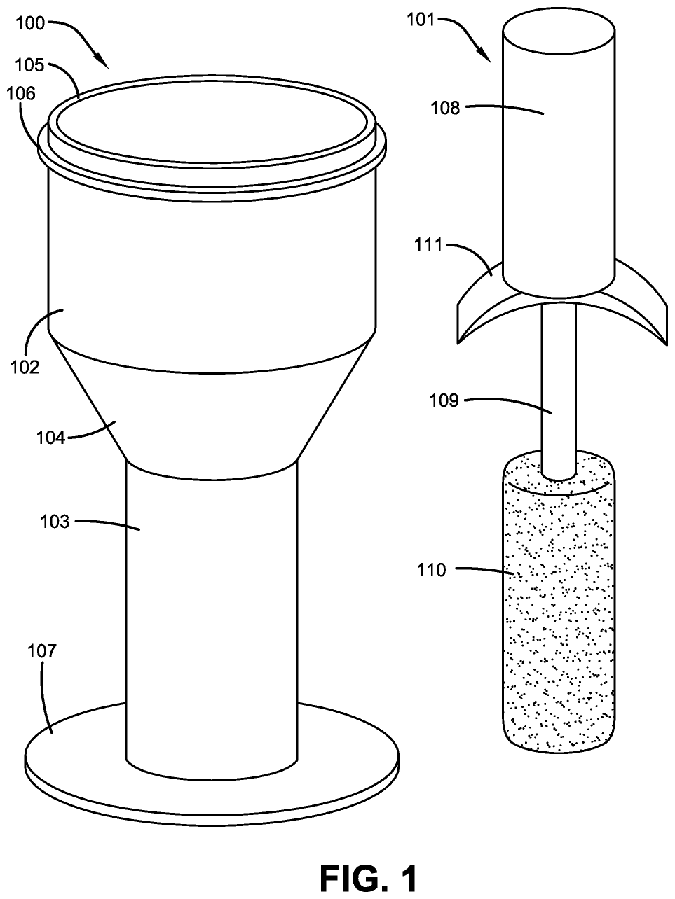

Referring now to the drawings and initially to FIG. 1, there is shown a paint roller container 100 and a paint roller 101. The paint roller container 100 includes a hollow, enlarged cylinder 102, an annular, narrower reservoir 103, and a tapered portion 104 between the cylinder 102 and reservoir 103. The tapered portion 104 may be anywhere between a high taper and a low taper, or a curve or other geometry, depending on the length of the cylinder 102, the size of the paint roller 101, the length of the reservoir 103, a type of paint in reservoir 103, and other factors. The tapered portion 104 may smoothly and continuously connect with the cylinder 102 and reservoir 103 or connect with the cylinder 102 and reservoir 103 at a steep angle. The reservoir 103 may be tapered or curved as well, provided that the reservoir is still able to store the paint roller 101 and an amount of paint (e.g., sufficient to coat the paint roller 101). The reservoir 103 being tapered may narrow the paint to a more central location around the paint roller 101 to easily recoat the paint roller 101. The cylinder 102 may have an open end 105. The open end 105 may be smooth and/or fitted in conjunction with a male end 106. The male end 106 may be a lip, a threaded surface, or another structure suitable to stabilize or receive a cap. Alternatively, the open end 105 may serve as male end, able to receive snap-on caps or other caps that do not need a male end 106.

The paint roller container 100 also includes an enlarged base 107 connected to a closed end of the reservoir 103. The enlarged base 107 supports the paint roller container 100 and allows the paint roller container 100 to stand on a flat surface. The enlarged base 107 may be round, rectangular, or another shape suitable to stabilize the paint roller container 100. The connection between the enlarged base 107 and the reservoir 103 may be tapered or occur at a sharper angle. The enlarged base 107 is wider than the reservoir 103, and may be wider or smaller than the cylinder 102 depending on the geometry of the paint roller container 100 (e.g., height and width of entire paint roller container 100 or sections thereof, volume of paint roller container 100, ratios of geometries between sections of paint roller container 100, weight or thickness of paint roller container 100, relative size or weight of paint roller container 100 in proportion to paint roller, et cetera).

The paint roller container 100 can be plastic or be any suitable rigid and/or flexible material or combinations thereof. The paint roller container 100 may be manufactured using an injection mold procedure. Molten plastic material can be injected into a container-shaped mold, where the plastic material hardens and solidifies. The plastic temperature, injection speed, mold temperature and other factors may depend on the type of plastic, the type of molding procedure, and other pertinent factors. Alternatively, the paint roller container may be made piece-wise, with the pieces being connected together at a later point.

The paint roller 101 includes an elongated handle 108, a roller frame 109 projecting axially outward from the handle 108, and a roller cover 110 supported on the roller frame 109. The elongated handle 108 may be any suitable rigid and/or flexible material, including but not limited to plastic, wood, or aluminum. In embodiments, handle 108 can be rubberized, textured, or otherwise easy to grip when wet, and/or can include channels or texture to allow liquid to run off to improve grip.

The elongated handle 108 may be a cylinder, a hand-configured grip, or any other reasonable shape. The roller frame 110 may have a rotational cage upon which the roller cover 110 is secured. The rotational cage allows the roller cover 110 to spin around while the elongated handle 108 is stationary. An axle can be provided as a component of roller frame 110 to permit the rotational cage to rotate with respect to the handle 108. The roller cover 110 may be foam, fabric, or any other suitable material that can absorb and distribute paint.

The elongated handle 108 may have an roller retainer 111. The roller retainer 111 allows the paint roller 101 to be securely arranged on the open end 105 of the paint roller container 100 or other surfaces (e.g., “hooking” paint roller 101 to container 100 with the handle outside container 100, “hooking” paint roller 101 to another edge or surface separate from container 100). The roller retainer 111 may be a hook or another curved structure sufficient to hold or balance paint roller 101 under force of gravity.

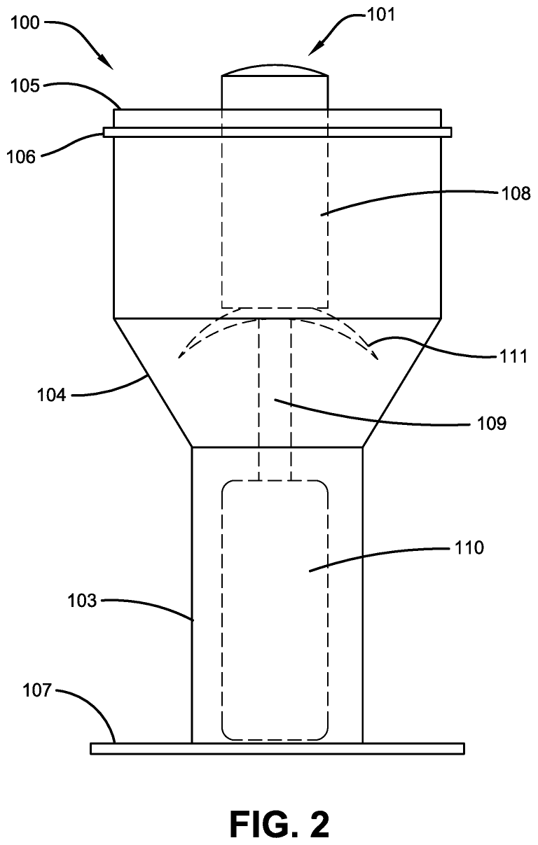

As shown in FIG. 2, the reservoir 103 is configured to hold paint and at least a portion of paint roller 101. In some embodiments, reservoir 103 can be approximately twice of the diameter (or another widthwise measurement) of the roller cover 110. However, reservoir 103 can be any dimension sufficient to allow roller cover 110 to be arranged therein. In some embodiments, reservoir 103 is at least as long as the length of the roller cover 110 so the entire roller cover 110 can be saturated with paint when the paint roller 101 is inserted into the reservoir 103. The reservoir 103 may be longer than the roller cover 110, and therefore the roller frame 109 may be longer in order for the roller cover 110 to be completely immersed in the reservoir 103. In addition, in embodiments where the reservoir 103 is tapered, the closed end of the paint roller 101 can be wide enough to accept the roller cover 110. In embodiments, cylinder 102 is at least as long as roller cover 110.

To begin painting, the reservoir 103 can be filled with a selected paint (or other liquid, gel, et cetera, to be applied using a roller). Paint roller 101 can be into the reservoir 103, immersing some or all of roller cover 110 in paint stored therein. As roller cover 110 is arranged into the volume of reservoir 103, paint will be driven up, covering more of the roller cover 110.

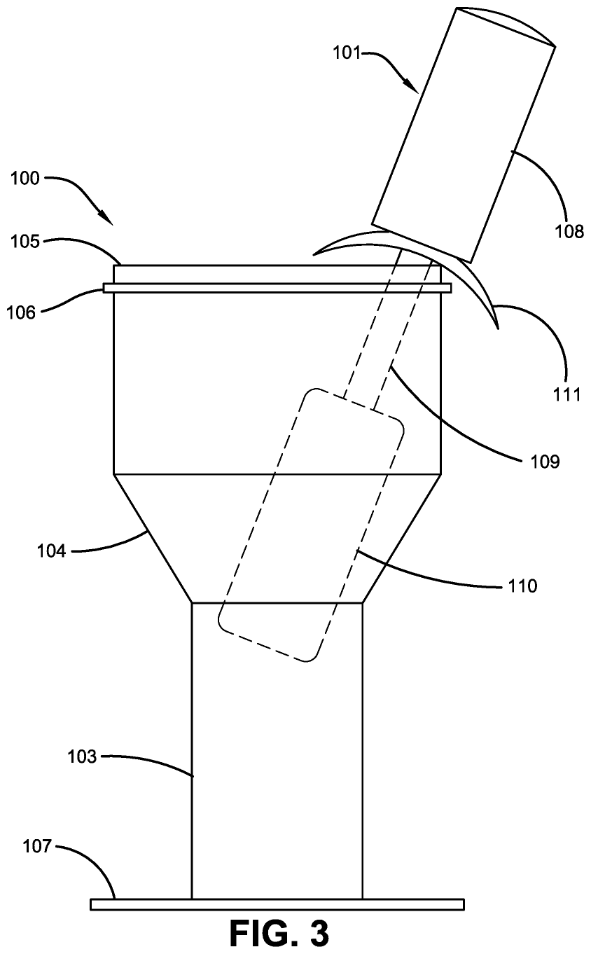

After being arranged in paint, paint roller 101 can be withdrawn from the reservoir 103 as shown in FIG. 3. After paint coats roller cover 110, paint roller 101 can be rolled around, or scraped along, the inside of the cylinder 102. This process can remove excess paint from the roller cover 110, which then drains down the cylinder 102 and the tapered portion 104 and back into the reservoir 103, allowing the excess paint to be reused whenever the roller cover 110 is returned to reservoir 103 for additional paint. The painter may then remove the paint roller 101 from the paint roller container 100 and begin the painting process. The painter can perform such steps while the paint roller container 100 is stationary on a surface or while being held.

Paint roller 101 is designed to be effective at painting narrow or hard-to-reach areas, such as between picket fences, behind toilets, or any other tight areas. Typically, such areas are reached with a paint brush. However, paint brushes are slow to use, and can result in a different texture or appearance of applied paint than areas that were painted using a typical paint roller. The paint roller 101 can be used quickly and keep the same appearance as other areas painted using a typical paint roller. In embodiments, variants of roller cover 110 can be made available to provide different naps or thicknesses, stiffnesses, paint capacities, materials (e.g., mohair, lamb's wool, foam, synthetic fiber, et cetera), textures, et cetera, to mimic the application characteristics of traditional paint rollers. The painter roller 101 is also cleaner and more precise to use than a paint sprayer. In between painting, the painter may place the paint roller 101 inside the paint roller container 100 or hang the paint roller 101 inside the paint roller container 100 using the roller retainer 111. When the roller cover 110 runs out of paint, the painter may reinsert the paint roller 101 into the reservoir 103 and repeat the process previously described. When the painting is complete, the painter may clean out the paint roller container 100 using soap and water. The roller cover 110 may be disposed of or clean out, depending on the painter's needs. If the painter disposes the roller cover 110, the painter may attach a fresh roller cover 110 to the roller frame 109 before painting again.

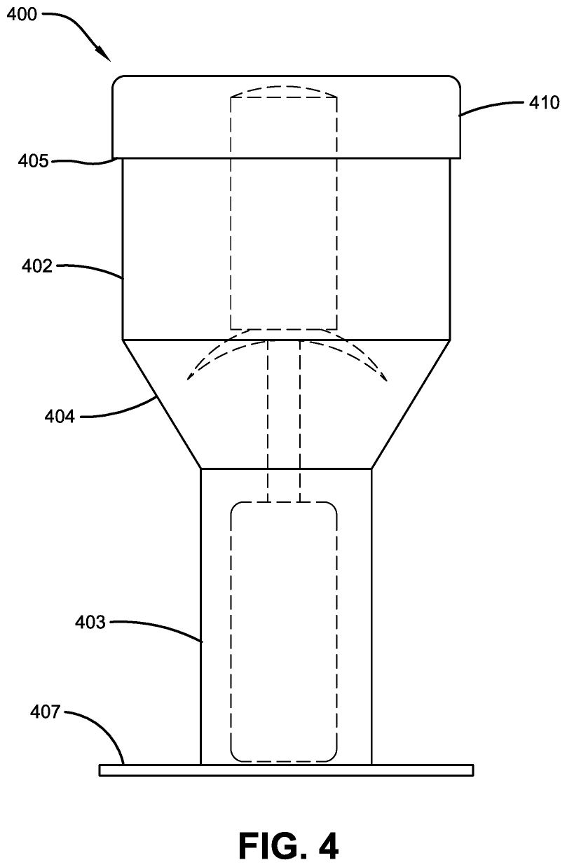

As shown in FIG. 4, there is the paint roller container 400 with a cap 410. Paint roller container 400 also includes cylinder 403, tapered portion 404, and base 407. The cap 410 may be removably connected to the open end 405 of the cylinder 402. The cap 410 may be removably connected to the open end 405 with the help of a male end 406. The male end 406 may be a lip, a threaded surface, or another structure suitable to stabilize or receive the cap 410. Alternatively, the open end 405 may be a threaded surface or another structure that can receive the cap 410.

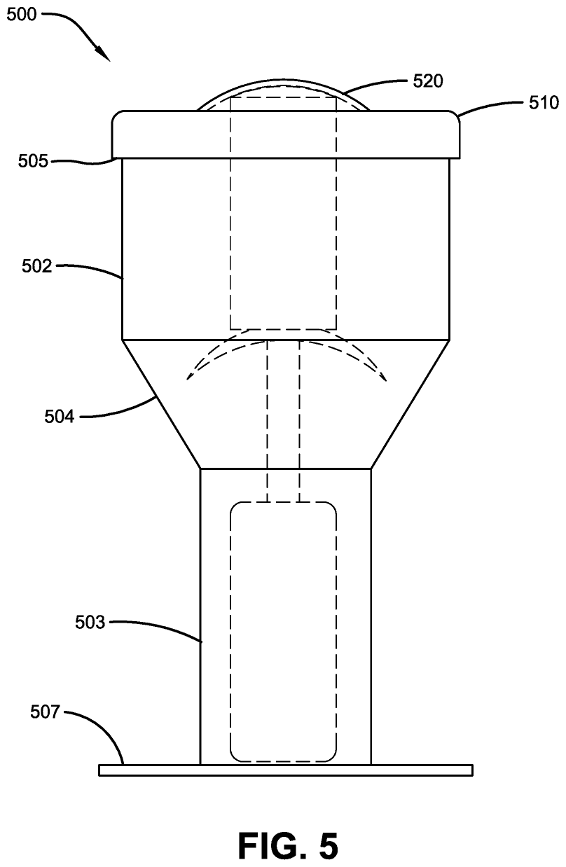

As shown in FIG. 5, a cap 510 for a paint roller container 500 may have a recess 520 that is configured to be tall and wide enough to encapsulate a portion of paint roller handle 508. Container 500 also includes cylinder 502, reservoir 503, tapered portion 504, and base 507. Alternatively, cap 510 may shaped to capture paint roller handle 508 without use of a recess, e.g., based on a taper or curve with an apex and portion there-around sized to capture paint roller handle 508.

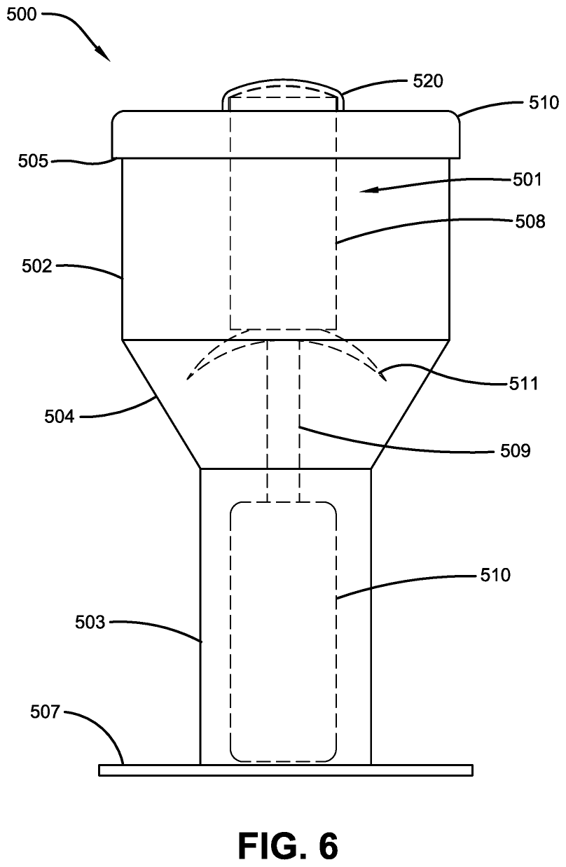

FIG. 6 shows paint roller 501 arranged in container 500 with cap 510 arranged on container 100 such that handle 508 extends beyond the open end 505 of container 500 but is captured by cap 510. Paint roller 501 also includes frame 509, and may optionally include retainer 511.

In embodiments such as those above, a cap (such as, e.g., 410 or 510) can be configured to create an airtight seal over the paint roller container (such as, e.g., 400 or 500). Such a seal allows a painter to store paint and/or the painter roller (such as, e.g., 401 or 501) in the paint roller container (such as, e.g., 400 or 500) for a prolonged period of time without the paint drying. The cap also assists in holding the paint roller upright inside the paint roller container. The cap may be any suitable rigid and/or flexible material, including but not limited to plastic, rubber, wood, or aluminum.

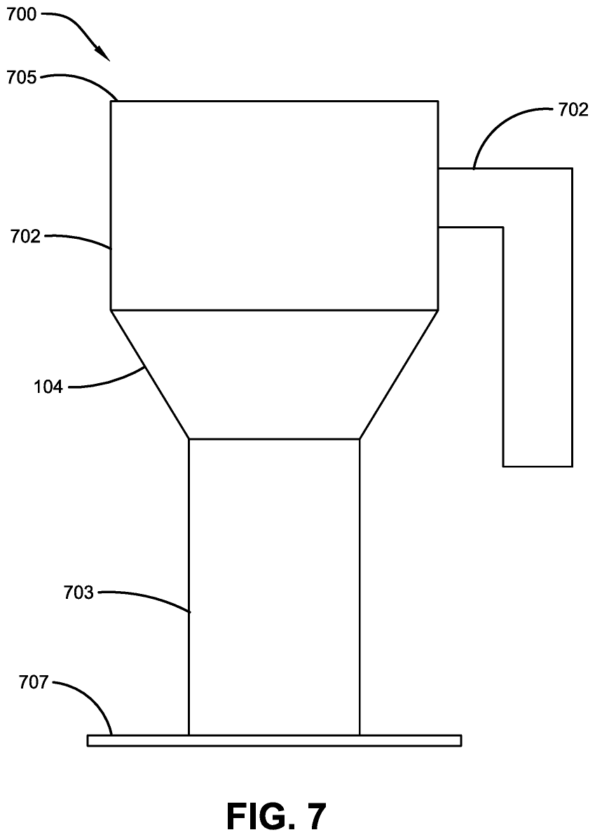

As shown in FIG. 7, there is the paint roller container 700 with a gripping element 710. Paint roller container 700 also includes, e.g., open end 705, cylinder 702, tapered portion 704, reservoir 703, and base 707. The gripping element 710 may be a pistol grip, a handle, molded ridges, or another suitable element for gripping. The gripping element 710 can be attached to the outer side of the cylinder 702. The gripping element 710 may be any suitable rigid and/or flexible material, including but not limited to plastic, wood, or aluminum. In embodiments, gripping element 710 can be rubberized, textured, or otherwise easy to grip when wet, and/or can include channels or texture to allow liquid to run off to improve grip. The gripping element 710 allows the painter to more easily hold the paint roller container 700 while painting.

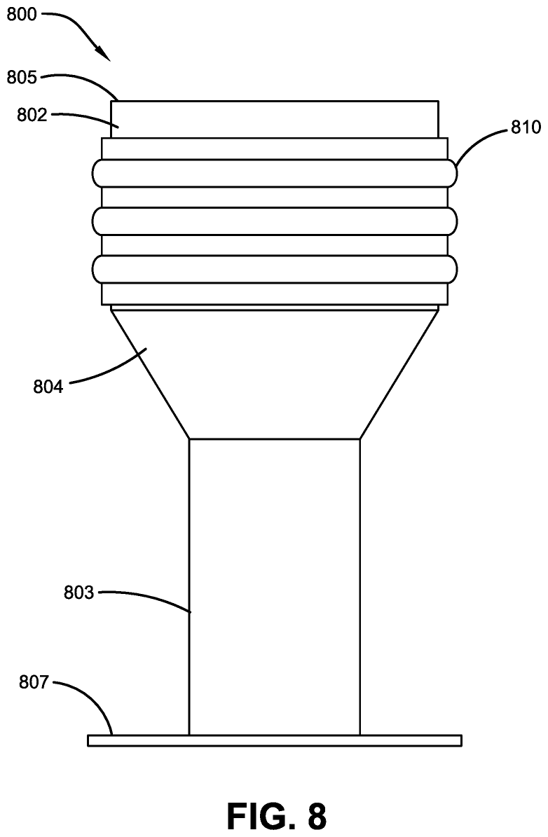

As shown in FIG. 8, there is the paint roller container 800 with a gripping element 810. Paint roller container 800 also includes, e.g., open end 805, cylinder 802, tapered portion 804, reservoir 803, and base 807. The gripping element 810 may be a pistol grip, a handle, molded ridges, or another suitable element for gripping. The gripping element 810 can be attached to the outer side of the cylinder 802. The gripping element 810 may be any suitable rigid and/or flexible material, including but not limited to plastic, wood, or aluminum. In embodiments, gripping element 810 can be rubberized, textured, or otherwise easy to grip when wet, and/or can include channels or texture to allow liquid to run off to improve grip. The gripping element 810 allows the painter to more easily hold the paint roller container 800 while painting.

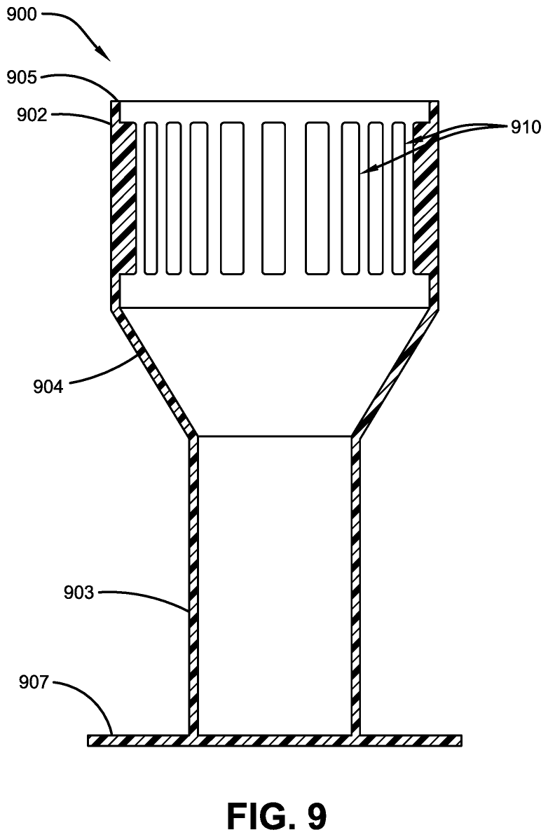

In addition, as shown in FIG. 9, there is a paint roller container 900 with an internal textured surface 910. Paint roller container 900 also includes, e.g., open end 905, cylinder 902, tapered portion 904, reservoir 903, and base 907. The internal textured surface 910 is located inside the cylinder 902. The internal textured surface 910 can be the same material as the cylinder 902, reservoir 903. The internal textured surface 910 may be vertical ridges, raised crisscross ridges, another raised surface, or combination thereof. The internal textured surface 910 more easily removes excess paint from a roller cover when a roller cover is rolled around the inside of the reservoir 103.

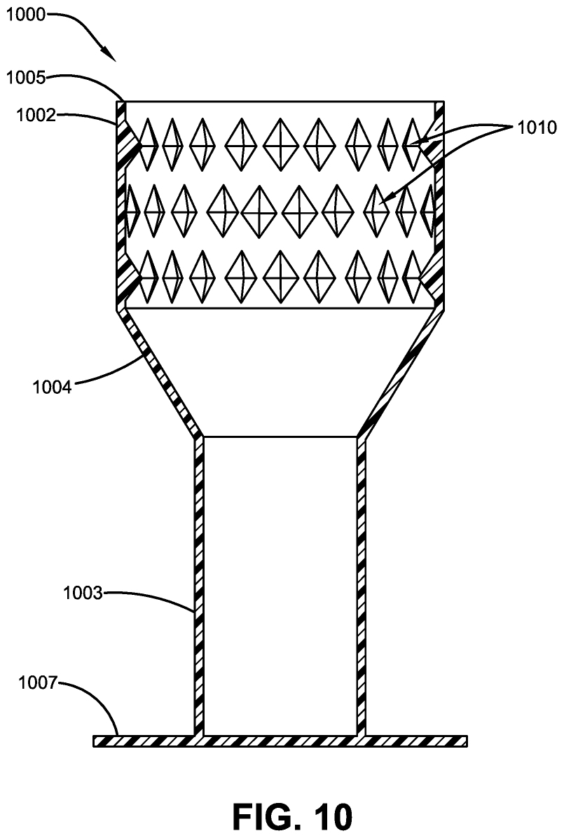

As shown in FIG. 10, there is a paint roller container 1000 with an internal textured surface 1010. Paint roller container 1000 also includes, e.g., open end 1005, cylinder 1002, tapered portion 1004, reservoir 1003, and base 1007. The internal textured surface 1010 is located inside the cylinder 1002. The internal textured surface 1010 can be the same material as the cylinder 1002, reservoir 1003, or other portions of container 1000. The internal textured surface 1010 may be vertical ridges, raised crisscross ridges, another raised surface, or combination thereof. The internal textured surface 1010 more easily removes excess paint from a roller cover when a roller cover is rolled around the inside of the cylinder 1002.

In embodiments, a textured surface (e.g., 910 or 1010) can include horizontal or downward-angled lips or recesses to capture or slow the downward running of excess paint. Such lips or recesses can allow for excess paint from the bottom of a roller to be distributed evenly across a roller cover by at least temporarily retaining a small amount of paint to be absorbed by the upper end of a roller cover.

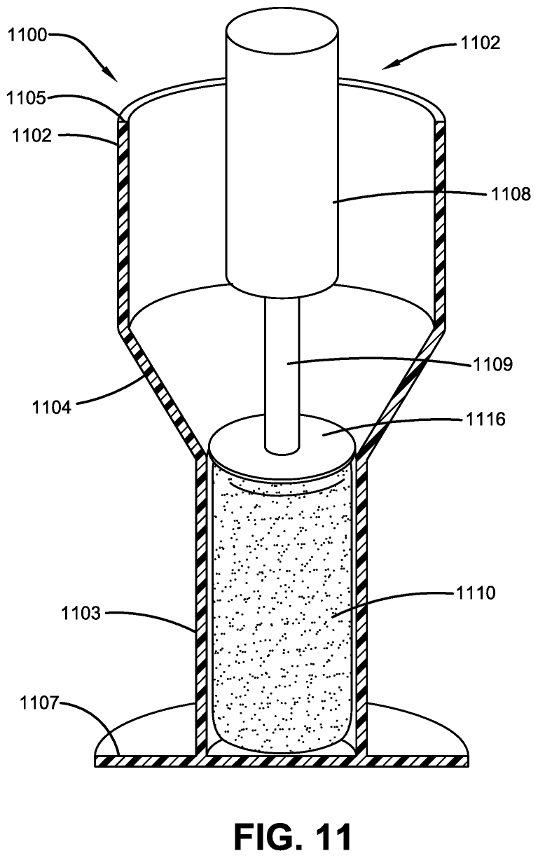

FIG. 11 illustrates a roller 1110 and container 1120 set 1100. Roller 1110 including a blocking member 1116. Roller 1110 also includes handle 1112, frame 1114, and cover 1118. Container 1120 includes cylinder 1122, reservoir 1124, and base 1126. Blocking member 1116 is sized to block reservoir 1124 to prevent paint from splashing or running out of reservoir 1124 when set 1100 is moved, reducing the amount of paint that may inadvertently get onto handle 1112. Blocking member 1116 can be flexible, movable, or removable to prevent it from getting stuck, impeding the use of roller 1110 in tight spaces, or reduce or prevent smudging of paint on blocking member 1116.

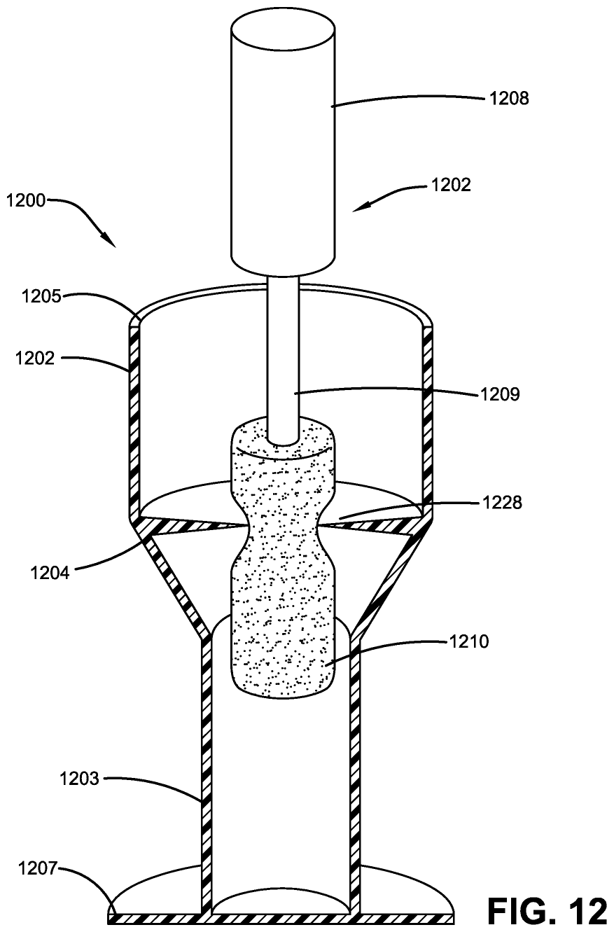

FIG. 12 illustrates a roller 1210 and container 1220 set 1200. Container 1220 including a pinching member 1228. Roller 1210 also includes handle 1212, frame 1214, and cover 1218. Container 1220 includes cylinder 1222, reservoir 1224, and base 1226. Pinching member 1228 can be a narrowed portion within cylinder 1222 configured to squeeze excess paint from roller 1210. Pinching member 1228 can be sized to squeeze, but not block, a roller frame and cover. In embodiments, pinching member 1228 can be flexible.

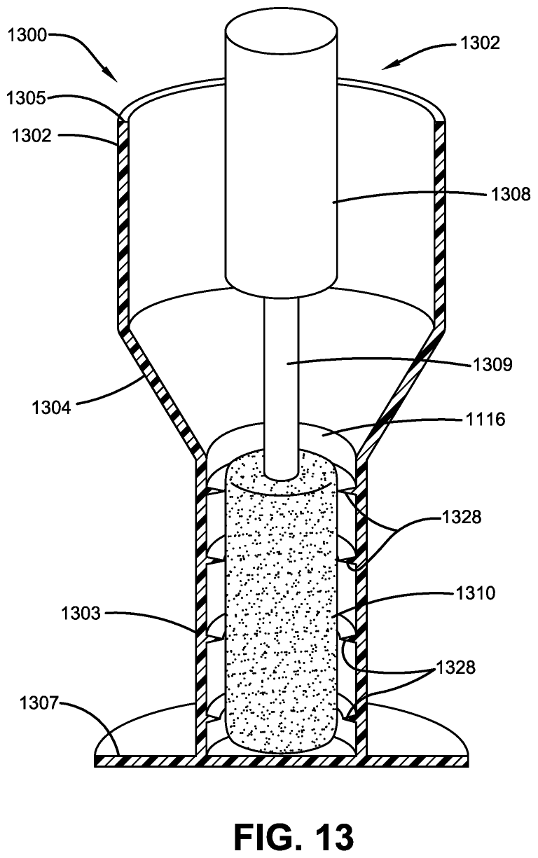

FIG. 13 illustrates a roller 1310 and container 1320 set 1300. Container 1320 including one or more ribs 1328. Roller 1310 also includes handle 1312, frame 1314, and cover 1318. Container 1320 includes cylinder 1322, reservoir 1324, and base 1326. Ribs 1328 can be of uniform size or be tapered to be wider or narrower at different heights within reservoir 1324, reducing paint splashing and holding paint roller 1310 in an upright position while permitting paint to flow throughout reservoir 1324. Ribs 1328 can assist with maintaining roller 1310 in a position when reservoir 1324 is wider than a roller cover.

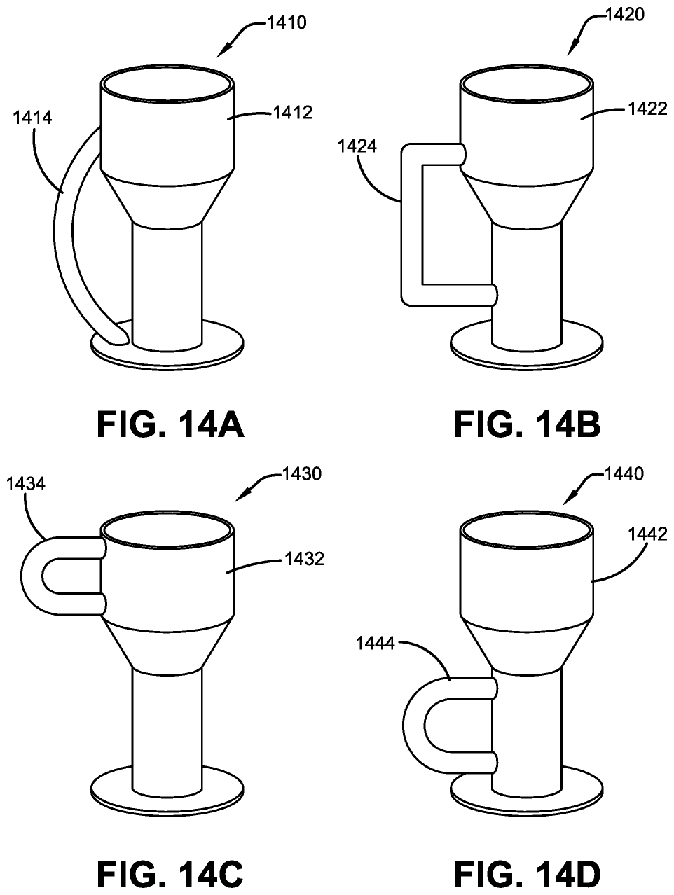

FIG. 14A, FIG. 14B, FIG. 14C, and FIG. 14D illustrate alternative handles for a container disclosed herein. FIG. 14A illustrates a container 1410 as disclosed herein with an alternate handle 1414. Handle 1414 can span from cylinder 1412 to base 1416. FIG. 14B illustrates a container 1420 as disclosed herein with an alternate handle 1424. Handle 1424 can span from cylinder 1422 to reservoir 1426. FIG. 14C illustrates a container 1430 as disclosed herein with an alternate handle 1434. Handle 1434 can span from one portion of cylinder 1432 to another portion of cylinder 1432. FIG. 14D illustrates a container 1440 as disclosed herein with an alternate handle 1444. Handle 1444 can span from one portion of reservoir 1442 to another portion of reservoir 1442. An alternative embodiment, a handle could span from a reservoir portion to a base portion. Various other handle, strap, or holding or retention options will be appreciated by those of skill in the art.

Embodiments herein can combine or mix-and-match features described without departing from the scope or spirit of the innovation. For example, a grip, handle, or other part of any embodiment could include a non-slip texture or material. Embodiments not showing aspects for splash-proofing or wiping excess paint from a roller being withdrawn could include such aspects, and such aspects can be located at other places within a container (e.g., higher toward or at the top or lower toward or at the bottom).

Embodiments herein can be made through a variety of techniques without departing from the scope or spirit of the innovation. For example, the container may be molded as a single piece or assembled in one or more steps from multiple pieces. Materials used in containers or rollers can be lightweight, washable, heat resistant, shatterproof, et cetera.

Variants of containers herein can be disassemble-able using, e.g., threaded connections between portions. This can aid in the cleaning and service life of the container, including using different paint colors (or other liquids, gels, et cetera, to be applied by roller) in the same container. For example, a base may be removable from a reservoir to allow water or cleaner to flow through a container with the base removed. Those of ordinary skill in the art will understand how such embodiments can be realized without departing from the scope or spirit of the innovation.

Variants of rollers herein can include rollers with flexible frames or axles, frames or axles with joints or pivots, rollers that can be disassembled, and/or rollers that telescope or collapse. Those of ordinary skill in the art will understand how such embodiments can be realized without departing from the scope or spirit of the innovation.

Portions of components herein that come into contact or removably connect (e.g., cap and container, cap and roller handle, roller and blocking member, portions of roller, et cetera) can be removably connected or held in place using a variety of means, which may (but need not) include (and are not limited to) magnets, hook and loop material, snaps, threading, et cetera.

Although the present disclosure has been described with reference to certain embodiments, workers skilled in the art will recognize that changes may be made in form and detail without departing from the scope of the present disclosure Parameters identified as “approximate” or “about” a specified value are intended to include both the specified values and values within 10% of the specified value, unless expressly stated otherwise. Further, it is to be understood that the drawings accompanying the present disclosure may, but need not, be to scale, and therefore may be understood as teaching various ratios and proportions evident in the drawings.

What is claimed is:

1. A painting set, comprising:
a paint roller, comprising:
a paint roller frame extending along a long axis of the paint roller;
a paint roller handle fixedly attached to a first end of the frame; and
a paint roller cover attached over a second end of the paint roller frame, wherein at least a portion of the frame paint roller cover is configured to rotate with respect to the paint roller handle; and
a container for the paint roller, comprising:
a cylinder portion disposed at a top of the container, wherein the cylinder portion has an open top end configured to accept the paint roller;
a reservoir portion coupled with the cylinder portion, wherein the reservoir portion is configured to receive an amount of paint, wherein the reservoir portion is narrower than the cylinder portion, and wherein the reservoir portion has a larger cross-sectional dimension than a cross-sectional dimension of the paint roller cover; and
a base portion disposed at a bottom of the container, wherein the base portion is configured to stabilize the container.

2. The painting set of claim 1, comprising:
a roller retainer of the paint roller configured to removably support the paint roller on an edge of the cylinder portion.

3. The painting set of claim 1, comprising:
an internal textured surface of the cylinder configured to wipe excess paint from the paint roller cover.

4. The painting set of claim 1, comprising:
a cap configured to close the container.

5. The painting set of claim 4, wherein the cap forms an airtight seal with the container.

6. The painting set of claim 4, wherein the cap is configured to close the container with the paint roller stored within the container.

7. The painting set of claim 6, comprising:
a recess of the cap configured to accept the paint roller handle, wherein the paint roller handle is held in place and the paint roller is maintained in a position substantially aligned with a length of the container when the cap closes the container with the paint roller in the container.

8. The painting set of claim 1, comprising:
a container handle.

9. The painting set of claim 1, comprising:
a tapered portion of the container disposed between the cylinder portion and the reservoir portion.

10. The painting set of claim 1, wherein the base portion is removable from the reservoir portion.

11. A paint roller, comprising:
a paint roller frame extending along a long axis of the paint roller;
a paint roller handle fixedly attached to a first end of the frame; and
a paint roller cover attached over a second end of the paint roller frame, wherein at least a portion of the frame paint roller cover is configured to rotate with respect to the paint roller handle.

12. The paint roller of claim 11, comprising:
a roller retainer of the paint roller configured to removably support the paint roller on an edge of a container.

13. A container for a paint roller, comprising:
a cylinder portion disposed at a top of the container, wherein the cylinder portion has an open top end configured to accept the paint roller;
a reservoir portion coupled with the cylinder portion, wherein the reservoir portion is configured to receive an amount of paint, wherein the reservoir portion is narrower than the cylinder portion, and wherein the reservoir portion has a larger cross-sectional dimension than a cross-sectional dimension of the paint roller cover; and
a base portion disposed at a bottom of the container, wherein the base portion is configured to stabilize the container.

14. The container of claim 13, comprising:
an internal textured surface of the cylinder configured to wipe excess paint from the paint roller cover.

15. The container of claim 13, comprising:
a cap configured to close the container.

16. The container of claim 15, wherein the cap forms an airtight seal with the container.

17. The container of claim 15, wherein the cap is configured to close the container with the paint roller stored within the container.

18. The container of claim 17, comprising:
a recess of the cap configured to accept the paint roller handle, wherein the paint roller handle is held in place and the paint roller is maintained in a position substantially aligned with a length of the container when the cap closes the container with the paint roller in the container.

19. The container of claim 13, comprising:
a container handle.

20. The container of claim 13, comprising:
a tapered portion of the container disposed between the cylinder portion and the reservoir portion.
